(19) United States
(12) Patent Application Publication
(10) Pub. No.: US 2023/0326369 A1
(43) Pub. Date: Oct. 12, 2023

(54) METHOD AND APPARATUS FOR GENERATING SIGN LANGUAGE VIDEO, COMPUTER DEVICE, AND STORAGE MEDIUM

(71) Applicant: Tencent Technology (Shenzhen) Company Limited, Shenzhen (CN)

(72) Inventors: Ju WANG, Shenzhen (CN); Yong Lang, Shenzhen (CN); Fanbo Meng, Shenzhen (CN); Tongtong Shen, Shenzhen (CN); Qiang He, Shenzhen (CN); Jian Yu, Shenzhen (CN); Ning Wang, Shenzhen (CN); Jianxiang Li, Shenzhen (CN); Yun Peng, Shenzhen (CN); Xu Zhang, Shenzhen (CN); Wei Jiang, Shenzhen (CN); Pei Zhang, Shenzhen (CN); He Cao, Shenzhen (CN); Yanfeng Wang, Shenzhen (CN); Yanxia Qin, Shenzhen (CN); Jinsuo Liu, Shenzhen (CN); Kai Liu, Shenzhen (CN); Jingjing Zhang, Shenzhen (CN); Wenjun Duan, Shenzhen (CN); Jingrong Bi, Shenzhen (CN); Liren Zhu, Shenzhen (CN); Liang Zhao, Shenzhen (CN); Yixiang Wang, Shenzhen (CN); Meiliang Fang, Shenzhen (CN)

(21) Appl. No.: 18/208,765

(22) Filed: Jun. 12, 2023

Related U.S. Application Data
(63) Continuation of application No. PCT/CN2022/130862, filed on Nov. 9, 2022.

(30) Foreign Application Priority Data
Jan. 30, 2022 (CN) 202210114157.1

(51) Int. Cl. G09B 21/00; G06T 19/20; G06V 30/10; G06F 40/30

(52) U.S. Cl. CPC G09B 21/009; G06T 19/20; G06V 30/10; G06F 40/30; G06T 2219/2004

(57) ABSTRACT

The embodiments of this application disclose a method for generating sign language video performed by a computer device. The method includes the following steps: acquiring acquiring listener text, the listener text conforming to grammatical structures of a hearing-friendly person; performing summarization extraction on the listener text to obtain summary text, a text length of the summary text being shorter than a text length of the listener text; converting the summary text into sign language text, the sign language text conforming to grammatical structures of a hearing-impaired person; and generating the sign language video based on the sign language text.

### CROSS-REFERENCE TO RELATED APPLICATIONS

This application is a continuation application of PCT Patent Application No. PCT/CN2022/130862, entitled “METHOD AND APPARATUS FOR GENERATING SIGN LANGUAGE VIDEO, COMPUTER DEVICE, AND STORAGE MEDIUM” filed on Nov. 9, 2022, which claims priority to Chinese Patent Application No. 202210114157.1, entitled “METHOD AND APPARATUS FOR GENERATING SIGN LANGUAGE VIDEO, COMPUTER DEVICE, AND STORAGE MEDIUM” filed on Jan. 30, 2022, all of which is incorporated herein by reference in its entirety.

### FIELD OF THE TECHNOLOGY

The embodiments of this application relate to the field of artificial intelligence, and in particular to, a method and apparatus for generating sign language video, a computer device, and a storage medium.

### BACKGROUND OF THE DISCLOSURE

With the development of computer technology, even though a hearing-impaired person cannot hear sounds, they can understand the content assisted by sign language video. The sign language video, generated by a computer device, is used for expressing contents. For example, when watching video, the hearing-impaired person often cannot watch the video normally without subtitles. Therefore, audio contents corresponding to the video need to be translated into respective sign language video; the sign language video may be acquired during the playing of the video, and the sign language video may be played in a video picture.

In the related art, sign language video cannot express contents well, and the accuracy of the sign language video is low.

### SUMMARY

According to various embodiments provided in this application, a method and apparatus for generating sign language video, a computer device, and a storage medium are provided.

In one aspect, the embodiments of this application provide a method for generating sign language video executed by a computer device, including:
acquiring listener text, the listener text being texts conforming to grammatical structures of a hearing-friendly person;
performing summarization extraction on the listener text to obtain summary text, a text length of the summary text being shorter than a text length of the listener text;
converting the summary text into sign language text, the sign language text being texts conforming to grammatical structures of a hearing-impaired person; and
generating sign language video based on the sign language text.

In another aspect, this application further provides a computer device. The computer device includes a memory and a processor, the memory storing computer-readable instructions, and the computer-readable instructions, when executed by the processor, causing the computer device to implement steps of the method for generating sign language video.

In another aspect, this application further provides a non-transitory computer-readable storage medium. The computer-readable storage medium stores thereon computer-readable instructions, the computer-readable instructions, when executed by a processor of a computer device, causing the computer device to implement steps of the method for generating sign language video.

Details of one or more embodiments of this application are set forth in the drawings and description below. Other features, objectives, and advantages of this application become apparent from the specification, drawings, and claims.

### BRIEF DESCRIPTION OF THE DRAWINGS

To illustrate the technical solutions in the embodiments of this application or conventional technology more clearly, the following briefly describes the drawings required for describing the embodiments or the conventional technology. It is obvious that the drawings in the following description are only some embodiments of this application. The ordinarily skilled in the art would have been able to acquire other drawings according to these drawings without involving any inventive effort.

FIG. 1 illustrates a diagram of an implementation environment provided by one exemplary embodiment of this application.

FIG. 2 illustrates a flowchart of a method for generating sign language video provided by one exemplary embodiment of this application.

FIG. 3 illustrates a schematic diagram of sign language video not synchronizing with its corresponding audio provided by one exemplary embodiment of this application.

FIG. 4 illustrates a flowchart of a method for generating sign language video provided by another exemplary embodiment of this application.

FIG. 5 illustrates a flowchart of a speech recognition process provided by one exemplary embodiment of this application.

FIG. 6 illustrates a framework structure diagram of an encoder-decoder provided by one exemplary embodiment of this application.

FIG. 7 illustrates a flowchart of a translation model training process provided by one exemplary embodiment of this application.

FIG. 8 illustrates a flowchart of virtual object establishment provided by one exemplary embodiment of this application.

FIG. 9 illustrates a flowchart of a method for generating summary text provided by an exemplary embodiment of this application.

FIG. 10 illustrates a schematic diagram of a dynamic path planning algorithm provided by one exemplary embodiment of this application.

FIG. 11 illustrates a process diagram of a method for generating summary text provided by an exemplary embodiment of this application.

FIG. 12 illustrates a flowchart of a method for generating sign language video provided by one exemplary embodiment of this application.

FIG. 13 illustrates a structural block diagram of an apparatus for generating sign language video provided by an exemplary embodiment of this application.

FIG. 14 is a structural block diagram of a computer device provided by one exemplary embodiment of this application.

### DESCRIPTION OF EMBODIMENTS

The technical solutions in the embodiments of this application will be clearly and completely described below in conjunction with the drawings in the embodiments of this application. Obviously, the described embodiments are only a part of the embodiments of this application, and not all of them. All other embodiments, obtained by the ordinarily skilled in the art based on the embodiments of this application without creative efforts, shall fall within the protection scope of this application.

It is to be understood that reference herein to “a number” means one or more, and “a plurality” means two or more. “And/or”, describing an associated relationship of an associated object, represents that there may be three relationships, for example, A and/or B, may represent that there are three cases of A alone, A and B together, and B alone. The character “I” generally indicates an “or” relationship between the associated objects.

The names involved in the embodiments of this application are described below:

Sign language, a language used by a hearing-impaired person, is composed of information such as gestures, body movements, and facial expressions. According to the different word orders, the sign language may be divided into a natural sign language and a gesture sign language, the natural sign language being used by a hearing-impaired person and the gesture sign language being used by a hearing-friendly person. The natural sign language and the gesture sign language may be distinguished by different word orders. For example, the sign language sequentially executed according to each phrase in “cat/mouse/catch” is a natural sign language; and the sign language sequentially executed according to each phrase in “cat/catch/mouse” is a gesture sign language, “/” being used for separating each phrase.

Sign language texts are texts that conform to the reading habits and grammatical structures of a hearing-impaired person. The grammatical structures of a hearing-impaired person refer to the grammatical structures of normal texts read by the hearing-impaired person. A hearing-impaired person refers to a person with hearing impairment.

Listener texts are texts that conform to the grammatical structures of a hearing-friendly person. The grammatical structures of a hearing-friendly person refer to the grammatical structures of a text conforming to the language habit of the hearing-friendly person, for example, a Chinese text conforming to the language habit of Mandarin or an English text conforming to the language habit of English. The language of the listener text is not limited in this application. A hearing-friendly person, as opposed to a hearing-impaired person, refers to a person without hearing impairment.

For example, as in the above example, “cat/catch/mouse” may be a listener text that conforms to the grammatical structures of a hearing-friendly person, and “cat/mouse/catch” may be a sign language text. There are some differences in the grammatical structures between the listener text and the sign language text.

In the embodiments of this application, applying artificial intelligence to the field of sign language interpretation can automatically generate sign language video based on the listener text and solve the problem of the sign language video not synchronizing with the corresponding audio.

In daily life, when watching a video program such as a news broadcast and a ball game relay broadcast, a hearing-impaired person cannot watch it normally because there are no corresponding subtitles. Or when listening to an audio-type program, such as a broadcast, a hearing-impaired person may not be able to listen normally without the audio-corresponding subtitles. In the related art, an audio content is generally acquired in advance; sign language video is prerecorded according to the audio content, and is then synthesized with the video or audio before being played, so that a hearing-impaired person can learn the corresponding audio content via the sign language video.

However, since sign language is a language composed of gestures, when the expression contents are the same, the durations of sign language video are longer than the durations of audio, thus resulting in that the time axis of the generated sign language video is not aligned with the audio time axis. Especially for the video, it is easy to lead to the problem that the sign language video is not synchronized with the corresponding audio, thus affecting the understanding of audio contents by a hearing-impaired person. For video, since the audio contents and the video contents are identical, it may also cause a difference between the contents expressed in sign language and the video picture. In the embodiments of this application, by acquiring listener text and timestamps corresponding to video, summarization extraction is performed on the listener text to obtain summary text, to shorten the text length of the listener text. Therefore, a time axis of sign language video generated based on the summary text may be aligned with an audio time axis of audio corresponding to the listener text, thereby solving the problem of the sign language video not synchronizing with the corresponding audio.

The method for generating sign language video provided by the embodiments of this application is applicable to various scenarios to facilitate the lives of a hearing-impaired person.

In one possible application scenario, the method for generating sign language video provided by the embodiments of this application is applicable to a real-time sign language scenario. In some embodiments, the real-time sign language scenario may be an event live broadcast, a news live broadcast, a conference live broadcast, and the like. The live broadcast content may be provided with sign language video using the method provided by the embodiments of this application. Taking a news live broadcast scenario as an example, the audio corresponding to the news live broadcast is converted into listener text; the listener text are compressed to obtain summary text; and sign language video is generated based on the summary text to be synthesized with the news live broadcast video and pushed to a user in real time.

In another possible application scenario, the method for generating sign language video provided by the embodiments of this application is applicable to an offline sign language scenario, and there are offline texts in the offline sign language scenario. In some embodiments, the offline sign language scenario may be a reading scenario of text materials, which can directly convert text contents into sign language video for playing.

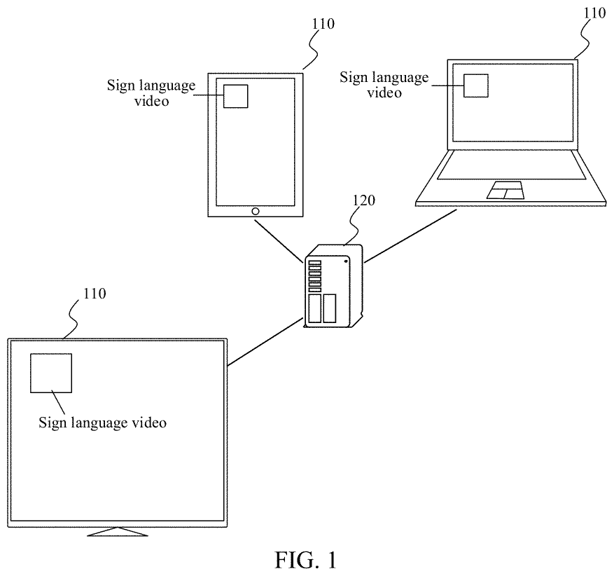

Referring to FIG. 1, a diagram of an implementation environment provided by an exemplary embodiment of this application is illustrated. The implementation environment may include a terminal 110 and a server 120.

The terminal 110 installs and runs a client capable of viewing sign language video, which may be an application or a web client. Taking the client being an application as an example, the application may be a video playing program, an audio playing program, and the like, which are not limited by the embodiments of this application.

For device types of the terminal 110, the terminal 110 may include but is not limited to a smartphone, a tablet, an e-book reader, a moving picture experts group audio layer III (MP3) player, a moving picture experts group audio layer IV (MP4) player, a laptop portable computer, a desktop computer, an intelligent voice interaction device, an intelligent household appliance, a vehicle terminal, and the like, which are not limited by the embodiments of this application.

The terminal 110 is connected to the server 120 through a wireless network or a wired network.

The server 120 includes at least one of a server, a plurality of servers, a cloud computing platform, and a virtualization center. The server 120 is used for providing background services to clients. In some embodiments, the method for generating sign language video may be executed by the server 120 or the terminal 110, or may be executed by the server 120 and the terminal 110 in cooperation, which are not limited by the embodiments of this application.

In the embodiments of this application, the mode of the server 120 generating the sign language video includes an offline mode and a real-time mode.

In one possible implementation, when the mode of the server 120 generating the sign language video is an offline mode, the server 120 stores the generated sign language video to a cloud; and when a user needs to watch the sign language video, the terminal 110 downloads the sign language video from the server by inputting a storage path of the sign language video at an application or a web client of the terminal 110.

In another possible implementation, when the mode of the server 120 generating the sign language video is a real-time mode, the server 120 pushes the sign language video to the terminal 110 in real time; and the terminal 110 downloads the sign language video in real time, so that a user may view the sign language video by running an application or a web client on the terminal 110.

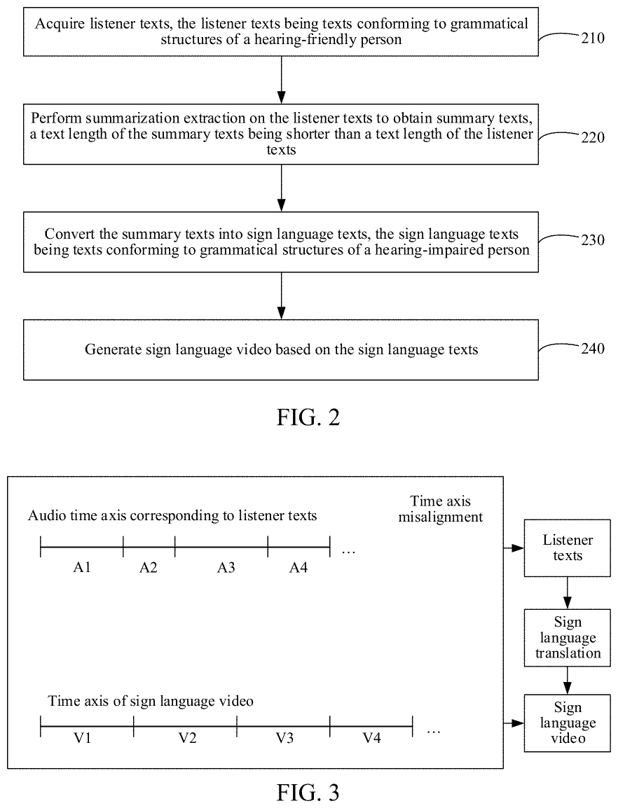

A method for generating sign language video in the embodiments of this application is described below. Referring to FIG. 2, a flowchart of a method for generating sign language video provided by one exemplary embodiment of this application is illustrated. In the embodiment, the method for generating sign language video is executed by a computer device, which may be a terminal 110 or a server 120. Specifically, the method includes the following steps:

Step 210: Acquire listener text, the listener text being texts conforming to grammatical structures of a hearing-friendly person.

In some embodiments, types of listener text may be offline texts or real-time texts.

Illustratively, when the listener text are offline texts, they may be texts obtained in a scenario such as a video or audio offline download.

Illustratively, when the listener text are real-time texts, they may be texts obtained in a scenario such as video live and simultaneous interpretation.

In some embodiments, sources of the listener text may be texts of the edited content, may also be texts extracted from a subtitle file, and may also be texts extracted from an audio file or a video file, and the like, which are not limited by the embodiments of this application.

In some embodiments, in the embodiments of this application, the language of the listener text is not limited to Chinese, but may be other languages, which are not limited by the embodiments of this application.

Step 220: Perform summarization extraction on the listener text to obtain summary text, a text length of the summary text being shorter than a text length of the listener text.

As shown in FIG. 3, when the same content is expressed, the duration of the sign language video (obtained by the listener text performing sign language translation) is longer than the audio duration of the audio corresponding to the listener text, resulting in that the audio time axis of the audio corresponding to the listener text are not aligned with the time axis of the finally generated sign language video, thus resulting in the problem that the sign language video is not synchronized with the audio corresponding thereto. A1, A2, A3, and A4 are used for representing timestamps corresponding to the listener text. V1, V2, V3, and V4 are used for representing time intervals of a sign language video axis. In one possible implementation, the computer device may synchronize the resulting sign language video with its corresponding audio by shortening the text length of the listener text.

Illustratively, the computer device may obtain the summary text by extracting statements in the listener text for expressing the full-text semantics of the listener text. By extracting the key statements, the summary text expressing the semantics of the listener text may be obtained, so that the sign language video can better express the content, further improving the accuracy of the sign language video.

Illustratively, the computer device obtains the summary text by performing text compression on statements of the listener text. By compressing the listener text, the acquisition efficiency of the summary text can be improved, improving the generation efficiency of the sign language video.

In addition, the ways of summarization extraction for listener text are different in response to the listener text being offline texts or real-time texts. When the listener text are offline texts, the computer device can obtain all the contents of the listener text, and thus can use any one of the above methods or a combination of both methods to obtain the summary text. When the listener text are real-time texts, since the computer device transmits the listener text in a real-time push manner, all the contents of the listener text cannot be obtained. The summary text can only be obtained by using a method of text compression on the statements of the listener text.

In another possible implementation, the computer device may synchronize the sign language video with its corresponding audio by adjusting the speed of the sign language gesture in the sign language video. Illustratively, when the duration of the sign language video is longer than the duration of the audio, the computer device may cause the virtual object executing the sign language gesture to keep natural shaking between the sign language statements and wait for the time axis of the sign language video to be aligned with the audio time axis; and when the duration of the sign language video is less than the duration of the audio, the computer device may cause the virtual object executing the sign language gesture to speed up the gesture action between the sign language statements so that the time axis of the sign language video is aligned with the audio time axis, thereby synchronizing the sign language video with the corresponding audio.

Step 230: Convert the summary text into sign language text, the sign language text being texts conforming to grammatical structures of a hearing-impaired person.

In the embodiments of this application, since the summary text are generated based on the listener text, the summary text are texts conforming to the grammatical structures of a hearing-friendly person. The grammatical structures of a hearing-impaired person are different from that of a hearing-friendly person. In order to improve the intelligibility of the sign language video to a hearing-impaired person, the computer device converts the summary text into sign language text conforming to the grammatical structures of a hearing-impaired person.

In one possible implementation, the computer device automatically converts the summary text into sign language text based on sign language translation technology.

Illustratively, a computer device converts summary text into sign language text based on natural language processing (NLP) technology.

Step 240: Generate the sign language video based on the sign language text.

The sign language video refers to video containing a sign language; and the sign language video may perform sign language expression on the content described by the listener text.

Depending on different types of the listener text, the computer device may generate the sign language video based on the sign language text in different modes.

In one possible implementation, when the type of listener text are offline texts, the mode in which the computer device generates the sign language video based on the sign language text are an offline video mode. In the offline video mode, the computer device generates a plurality of sign language video clips from a plurality of sign language text statements, and synthesizes the plurality of sign language video clips to obtain complete sign language video, and at the same time stores the sign language video to a cloud server for a user to download.

In another possible implementation, when the type of listener text are real-time texts, the mode in which the computer device generates the sign language video based on the sign language text are a real-time push stream mode. In the real-time push stream mode, the server generates sign language video clips from sign language text statements before pushing statement by statement to the client in the form of a video stream, for a user to load and play in real time through the client.

In summary, in the embodiments of this application, the summary text are obtained by performing text summarization extraction on the listener text, and then the text length of the listener text are shortened, so that the finally generated sign language video can keep synchronization with the audio corresponding to the listener text. Since the sign language video is generated based on the sign language text after the summary text are converted into the sign language text conforming to the grammatical structures of a hearing-impaired person, the sign language video can better express the content to a hearing-impaired person, improving the accuracy of the sign language video.

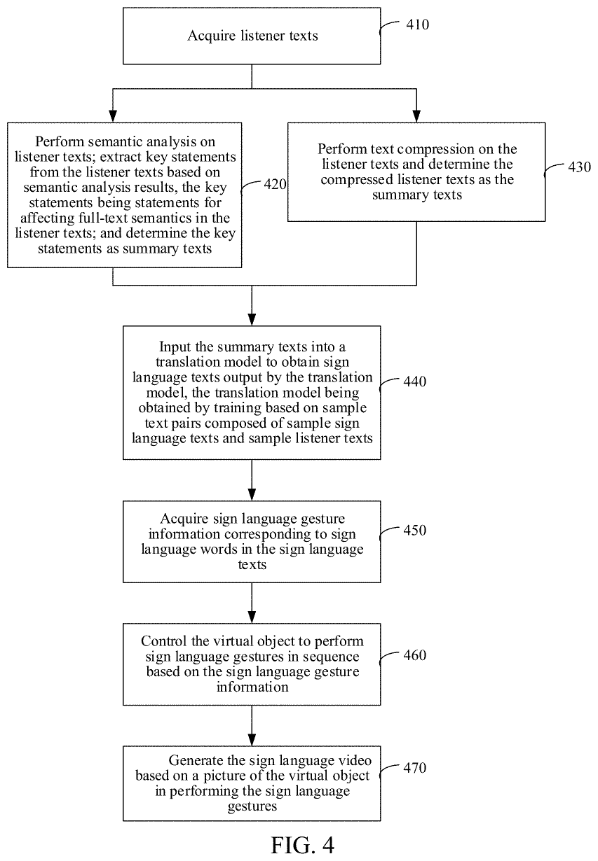

In the embodiments of this application, in one possible embodiment, the computer device may obtain the summary text by performing semantic analysis on the listener text and extracting statements expressing the full-text semantics of the listener text. In another possible implementation, the computer device may further obtain the summary text by dividing the listener text into statements and performing text compression on the divided statements. The above method is described below. Referring to FIG. 4, a flowchart of a method for generating sign language video provided by another exemplary embodiment of this application is illustrated. The method includes the following steps:

Step 410: Acquire listener text.

In the embodiments of this application, there are various ways in which the computer device obtains the listener text, which are described below.

In one possible implementation, in an offline scenario, such as a reading scenario, the computer device may directly obtain the input listener text, that is, the corresponding reading texts. In some embodiments, the listener text may be a word file, a pdf file, and the like, which are not limited by the embodiments of this application.

In another possible implementation, the computer device may obtain a subtitle file and extract the listener text from the subtitle file. The subtitle file refers to texts for displaying in a multimedia play picture, and the subtitle file may contain timestamps.

In another possible embodiment, in a real-time audio transmission scenario, such as a simultaneous interpretation scenario, a live conference scenario, the computer device may obtain an audio file, further perform speech recognition on the audio file to obtain a speech recognition result, and further generate the listener text based on the speech recognition result.

Since a hearing-impaired person cannot hear the sound and thus cannot obtain information from the audio file; the computer device converts the extracted sound into characters through speech recognition technology to generate the listener text.

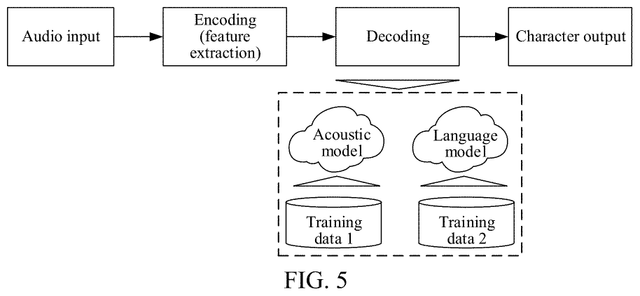

In one possible implementation, the process of speech recognition includes input-encoding (feature extraction)-decoding-output. As shown in FIG. 5, a process of speech recognition provided by one exemplary embodiment of this application is illustrated. Firstly, the computer device performs feature extraction on the input audio file, namely, converting the audio signal from the time domain to the frequency domain, to provide appropriate feature vectors for an acoustic model. In some embodiments, the extracted features may be linear prediction cepstral coefficients (LPCC), mel frequency cepstral coefficients (MFCC), and the like, which are not limited by the embodiments of this application. Furthermore, the extracted feature vectors are input into the acoustic model, the acoustic model being obtained by training data 1. The acoustic model is used for calculating the probability of each feature vector on acoustic features based on the acoustic features. In some embodiments, the acoustic model may be a word model, a word pronunciation model, a semi-syllable model, a phoneme model, and the like, which are not limited by the embodiments of this application. Further, a probability of a phrase sequence to which the feature vectors may correspond is calculated based on a language model. The language model is obtained by training data 2. The feature vectors are decoded by the acoustic model and the language model to obtain a character recognition result, and further obtain the listener text corresponding to the audio file.

In another possible implementation, in a video real-time transmission scenario, for example, a sports event live broadcast and an audio-visual program live broadcast, the computer device acquires a video file, and further performs character recognition on video frames of the video file to obtain a character recognition result, and then acquires the listener text.

Character recognition refers to a process of recognizing character information from the video frames. In a specific embodiment, the computer device may use optical character recognition (OCR) technology to perform character recognition; and OCR refers to a technology for performing analysis and recognition processing on an image file containing text materials to obtain character and layout information.

In one possible implementation, the process that the computer device obtains a character recognition result by recognizing the video frames of a video file via OCR is as follows: The computer device extracts video frames of the video file, and each video frame may be regarded as a static picture. Further, the computer device performs image pre-processing on the video frames to correct the imaging problems of the image, including geometric transformation (namely perspective, distortion, rotation, and the like), distortion correction, blur removal, image enhancement, light correction, and the like. Furthermore, the computer device performs text detection on the image pre-processed video frames, and detects the position, range, and layout of the texts. Still furthermore, the computer device performs character recognition on the detected texts, converts the text information in the video frames into pure text information, and then obtains a character recognition result. The character recognition result is the listener text.

Step 420: Perform semantic analysis on the listener text; extract key statements from the listener text based on semantic analysis results, the key statements being statements for expressing full-text semantics in the listener text; and determine the key statements as summary text.

In one possible implementation, the computer device applies a sentence-level semantic analysis method to the listener text. In some embodiments, the sentence-level semantic analysis method may be a shallow semantic analysis and a deep semantic analysis, which are not limited by the embodiments of this application.

In one possible implementation, the computer device extracts key statements from the listener text based on the semantic analysis result, filters non-key statements, and determines the key statements as summary text. The key statements are statements for expressing full-text semantics in the listener text, and non-key statements are statements other than the key statements.

In some embodiments, the computer device may perform, based on a text frequency-inverse document frequency (TF-IDF) algorithm, semantic analysis on the listener text to obtain the key statements and then generate the summary text. First, the computer device first counts the most frequently occurring phrases in the listener text. Further, weights are assigned to the occurred phrases. The weights are inversely proportional to the degree of commonality of the phrases, that is, phrases which are rare in ordinary times but appear mostly in the listener text are given a higher weight, while phrases which are common in ordinary times are given a lower weight. Further, the TF-IDF value is calculated based on the weight value of each phrase. The larger the TF-IDF value is, the more important the phrase is to the listener text. Therefore, several phrases with the largest TF-IDF value are selected as keywords, and the text statements in which the phrases located are key statements.

Illustratively, the content of the listener text is “The 2022 Winter Olympic Games will be held at XX; the mascot of this Winter Olympic Games is XXX; and the slogan of this Winter Olympic Games is ‘ ’. I feel proud”. Based on TF-IDF algorithm, the computer device performs semantic analysis on the listener text, and obtains the keyword “Winter Olympic Games”. Therefore, the statement where the keyword “Winter Olympics Games” is located is the key statement, that is, “The 2022 Winter Olympic Games will be held at XX; the mascot of this Winter Olympic Games is XXX; and the slogan of this Winter Olympic Games is ‘XXXXX’ ”. “I feel proud” is the non-key statement. The non-key statements are filtered, so the key statement “The 2022 Winter Olympic Games will be held at XX; the mascot of this Winter Olympic Games is XXX; and the slogan of this Winter Olympic Games is ‘ ’ ” is determined as the summary text. Step 430: Perform text compression on the listener text and determine the compressed listener text as the summary text.

In one possible implementation, the computer device performs text compression on the listener text according to a compression ratio, and determines the compressed listener text as summary text.

In some embodiments, different types of listener text have different compression ratios. When the listener text are offline texts, the compression ratio for each statement in the listener text may be the same or different. When the listener text are real-time texts, in order to reduce the delay, the statements of the listener text are compressed according to a fixed compression ratio to obtain the summary text.

In some embodiments, the value of the compression ratio depends on the application scenario. For example, in an interview scenario or a daily communication scenario, the compression ratio may take a larger value because words are more spoken and may contain less valid information in a sentence. However, in the news simulcast scenario, because of the concise expression, a sentence contains more effective information, so the value of the compression ratio is smaller. For example, in the interview scenario, the computer device performs text compression on the listener text at a compression ratio of 0.8, while in the news broadcast scenario, the computer device performs text compression on the listener text at a compression ratio of 0.3. Since different compression ratios may be determined for different application scenarios, the content expression of the sign language video may be matched with the application scenarios, further improving the accuracy of the sign language video.

In addition, in the embodiments of this application, the full-text semantics of the summary text obtained after performing text compression on the listener text is to be consistent with the full-text semantics of the listener text.

Step 440: Input the summary text into a translation model to obtain the sign language text output by the translation model, the translation model being obtained by training based on sample text pairs composed of sample sign language text and sample listener text.

Illustratively, the translation model may be a model built based on a basic framework of an encoder-decoder. In some embodiments, the translation model may be a recurrent neural network (RNN) model, a convolutional neural network (CNN) model, a long short-time memory (LSTM) model, and the like, which are not limited by the embodiments of this application.

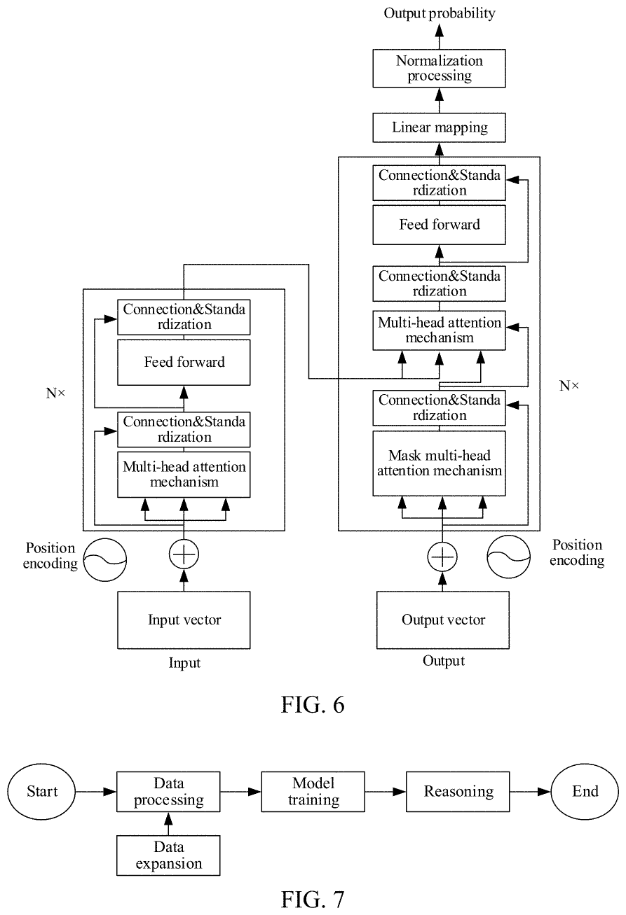

The basic framework structure of the encoder-decoder is shown in FIG. 6, and the framework structure is divided into two structural parts, encoder and decoder. In the embodiments of this application, the summary text are encoded by an encoder to obtain an intermediate semantic vector, and then the intermediate semantic vector is decoded by a decoder to obtain sign language text.

Illustratively, the process of encoding the summary text via the encoder to obtain the intermediate semantic vector is as follows: First, word vectors of the summary text are input. Further, word vectors and positional encoding are added as an input of a multi-head attention mechanism layer to obtain an output result of the multi-head attention mechanism layer; and at the same time, the word vectors and the positional encoding are input into a first Add & Norm layer to perform residual connection and perform normalization processing on activation values. Furthermore, the output result of the first Add & Norm layer and the output result of the multi-head attention mechanism layer are input into a feed forward layer to obtain an output result corresponding to the feed forward layer; and at the same time the output result of the first Add & Norm layer and the output result of the multi-head attention mechanism layer are input into a second Add & Norm layer again to obtain an intermediate semantic vector.

The process of further decoding the intermediate semantic vector through the decoder to obtain a translation result corresponding to the summary text is as follows: First, the output result of the encoder, that is, the intermediate semantic vector, is taken as an output of the decoder. Further, the intermediate semantic vector and the positional encoding are added as an input of the first multi-head attention mechanism layer before performing masked processing on the multi-head attention mechanism layer, thereby obtaining an output result. At the same time, the intermediate semantic vector and positional encoding are input into the first Add & Norm layer to perform residual connection and perform normalization processing on activation values. Furthermore, the output result of the first Add & Norm layer and the output result of the first multi-head attention mechanism layer subjected to masked processing are input into a second multi-head attention mechanism layer; and the output result of the encoder is input into the second multi-head attention mechanism layer to obtain the output result of the second multi-head attention mechanism layer. Furthermore, the output result of the first Add & Norm layer and the result of the first multi-head attention mechanism layer subjected to masked processing are input into the second Add & Norm layer to obtain the output result of the second Add & Norm layer. Furthermore, the output result of the second multi-head attention mechanism layer and the output result of the second Add & Norm layer are input into the feed forward layer to obtain an output result of the feed forward layer; and simultaneously the output result of the second multi-head attention mechanism layer and the output result of the second Add & Norm layer are input into a third Add & Norm layer to obtain an output result of the third Add & Norm layer. Still furthermore, linear mapping and normalization processing are performed on the output result of the feed forward layer and the output result of the third Add & Norm layer to finally obtain an output result of the decoder.

In the embodiments of this application, a translation model is obtained by training based on sample text pairs. The flow of the training is as shown in FIG. 7, and the main steps include data processing, model training, and reasoning. Data processing is used for labeling or data expansion of the sample text pairs.

In one possible implementation, sample text pairs may be composed of an existing sample listener text and sample sign language text, as shown in Table 1.

TABLE 1

| Sample listener text | Sample sign language text |
|---|---|
| I went to my favorite city in 2019. | 2-0-1-9/self/favorite/city/I/went/end/// |
| He eventually turned into a rock at | Huaguo |
| the top of Huaguo Mountain. | Mountain/top/he/eventually/turned |
| | into/rock/// |

In the sample sign language text, “I” is used for separating each phrase, and “///” is used for representing a punctuation, such as a period, exclamation mark, and question mark, indicating the end of a sentence.

In another possible implementation, the sample listener text may be obtained by using back translation (BT) method on the sample sign language text, further obtaining the sample text pairs.

Illustratively, the sample sign language text are shown in Table 2.

TABLE 2
Sample sign language text

I/want/be/programmer/diligent/do/do/do//a month/before/more///
Possible/willing to/do/programmer/person/more/need/work hard/learn///

“//” in the sample sign language text is used for representing a small punctuation, such as comma, dash, and semicolon.

Firstly, the sign language-Chinese translation model is trained using the existing sample listener text and the sample sign language text to obtain the trained sign language-Chinese translation model. Secondly, the sample sign language text in Table 2 are input into the trained sign language-Chinese translation model to obtain corresponding sample listener text, and further obtain the sample text pairs, as shown in Table 3.

TABLE 3

| Sample sign language text | Sample listener text |
|---|---|
| I/want/be/programmer/diligent/ | I want to be a programmer, being work |
| do/do/do//a month/before/more/// | hard and earning more money a month. |
| Possible/willing | There may be many people who are |
| to/do/programmer/person/more/ | willing to be programmers and need to |
| need/work hard/learn/// | learn hard. |
| Possible/willing | There may be many people who are |
| to/do/programmer/person/more/ | willing to be programmers and need to |
| need/work hard/learn/// | learn hard. |

The sample text pairs obtained in the two foregoing ways are shown in Table 4.

TABLE 4

| Sample listener text | Sample sign language text |
|---|---|
| I went to my favorite city in 2019. | 2-0-1-9/self/favorite/city/I/went/end/// |
| He eventually turned into a rock at | Huaguo Mountain/top/he/eventually/ |
| the top of Huaguo Mountain. | turned into/rock/// |
| I want to be a programmer, being | I/want/be/programmer/diligent/do/ |
| work hard and earning more | do/do//a month/before/more/// |
| money a month. | |
| There may be many people who | Possible/willing |
| are willing to be programmers | to/do/programmer/person/more/ |
| and need to learn hard. | need/work hard/learn/// |

Further, the computer device trains the translation model based on the sample text pairs shown in Table 4 to obtain a trained translation model. Moreover, it should be noted that the contents of the sample text pairs are illustrated by way of example in Table 4. The sample text pairs for training the translation model also include other sample listener text and corresponding sample sign language text, which will not be described in detail in the embodiments of this application.

Furthermore, reasoning verification is performed on the trained translation model, that is, inputting the sample listener text into the trained translation model to obtain translation results, as shown in Table 5.

TABLE 5

| Sample listener text | Translation result |
|---|---|
| Perhaps many people don't know that | Many people don't know that |
| the Chinese team is the only | China is the world 1 curling |
| professional team of curling around | professional team/// |
| the world. | |
| Under the premise of great pressure, | Extreme pressure preconditions |
| it is difficult to complete the task. | can be achieved easily not/// |

A space in the translation result indicates that each phrase is separated; world 1 indicates that it is unique in the world.

Sign language texts are obtained by translating summary text with translation model, which not only improves the generation efficiency of sign language text, but also learns the mapping from listener text to sign language text because the translated texts are trained by training samples composed of sample sign language text and sample listener text, so that accurate sign language text can be obtained by translation.

Step 450: Acquire sign language gesture information corresponding to sign language words in the sign language text.

In the embodiments of this application, after obtaining the sign language text corresponding to the summary text based on the translation model, the computer device further parses the sign language text into a single sign language word, such as eating, learning, and commending. Sign language gesture information corresponding to sign language words is established in advance in the computer device. The computer device matches sign language words in the sign language text to the corresponding sign language gesture information based on the mapping relationship between the sign language word and the sign language gesture information. For example, the sign language gesture information matched by the sign language word “Dian zan” is that the thumb is tilted upwards and the remaining four fingers are gripped.

Step 460: Control a virtual object to perform sign language gestures in sequence based on the sign language gesture information.

The virtual object is a digital person image created in advance through 2D or 3D modeling, and each digital person image includes facial features, hairstyle features, body features, and the like. In some embodiments, the digital person may be an artificial person image after being authorized by a real person, or may be a cartoon image and the like, which are not limited by the embodiments of this application.

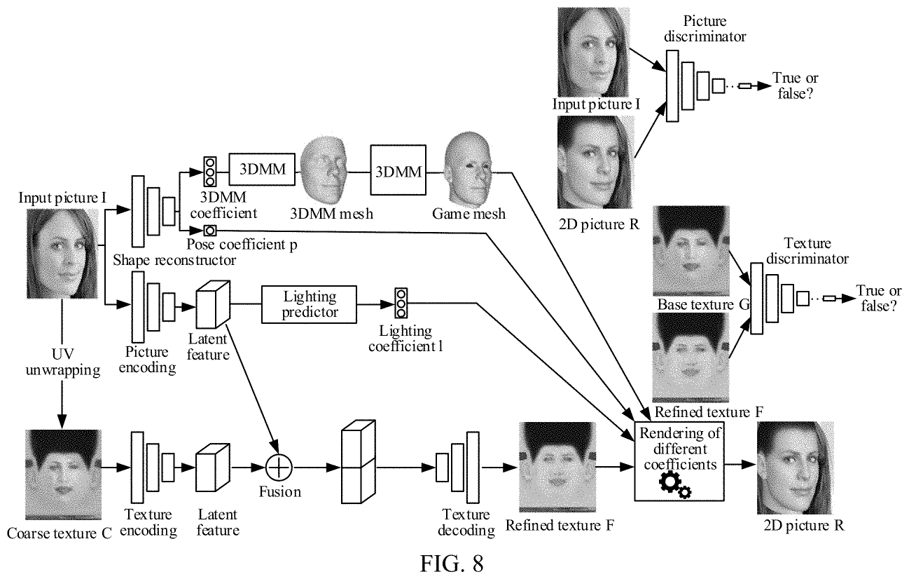

Illustratively, a process of virtual object creation in the embodiments of this application will be briefly described with reference to FIG. 8.

Firstly, the input image I is used for predict 3D morphable model (3DMM) coefficients and pose coefficient p using a pre-trained shape reconstructor, and then the 3DMM mesh is obtained. Then, the topology of 3DMM mesh is transformed into a game using a shape transfer model, that is, a game mesh is obtained. At the same time, picture decoding is performed on the picture I to further obtain latent features, and the lighting coefficient 1 is obtained based on a lighting predictor.

Further, the input picture I is performed with UV unwrapping into UV space according to the game mesh, resulting in a coarse texture C of the picture. Further, the coarse texture C is performed with texture encoding and latent features are extracted, and the picture latent features and the texture latent features are concatenated. Further, texture decoding is performed, resulting in a refined texture F (Refined texture F). Different parameters, such as a parameter corresponding to the game mesh, pose coefficients p, lighting coefficients l, and refined texture F, are input into a differentiable renderer to obtain a rendered 2D picture R. In order to make the output 2D picture R and the input picture I similar during training, a picture discriminator and a texture discriminator are introduced. The input picture I and the trained 2D picture R are discriminated real or fake by the picture discriminator, and the base texture G and the trained refined texture F are discriminated true or false by the texture discriminator.

Step 470: Generate the sign language video based on a picture of the virtual object in performing the sign language gestures.

The computer device renders the virtual object to perform sign language gestures into individual picture frames, and concatenates the individual still picture frames into a continuous dynamic video according to a frame rate, thereby forming a video clip. The video clip corresponds to a clause in the sign language text. To further enhance the color gamut of the video clips, the computer device transcodes the individual video clips into a YUV format. YUV refers to a pixel format in which a luminance parameter and a chrominance parameter are separately represented; Y represents luminance, that is, a gray value, and U and V represent chrominance, which are used for describing image color and saturation.

Further, the computer device concatenates the video clips to generate sign language video. Since sign language video can be generated by controlling a virtual object to execute a sign language gesture, the sign language video can be generated quickly, and the generation efficiency of the sign language video is improved.

In one possible implementation, when the listener text are offline text, the sign language video generation mode is an offline video mode; after a computer device splices video clips into sign language video, the sign language video is stored in a cloud server; and when a user needs to watch the sign language video, a complete video can be obtained by inputting a storage path of the sign language video in a browser or download software.

In another possible implementation, when the listener text are real-time texts, the sign language video generation mode is real-time mode, and in order to avoid delay, the computer device orders the video clips and pushes them frame by frame to the user client.

In the embodiments of this application, the synchronization of the finally generated sign language video and the corresponding audio can be improved by performing text summarization processing on the listener text in various ways; in addition, the summary text are converted into sign language text conforming to the grammatical structures of a hearing-impaired person; and the sign language video is regenerated based on the sign language text, thereby improving the accuracy of the sign language video to the listener text semantic expression, and automatically generating the sign language video, to achieve low cost and high efficiency.

In the embodiments of this application, when the listener text are offline texts, the computer device can obtain the summary text by performing semantic analysis on the listener text to extract key statements, and can also obtain the summary text by performing text compression on the listener text, and can also obtain the summary text by combining the foregoing two methods.

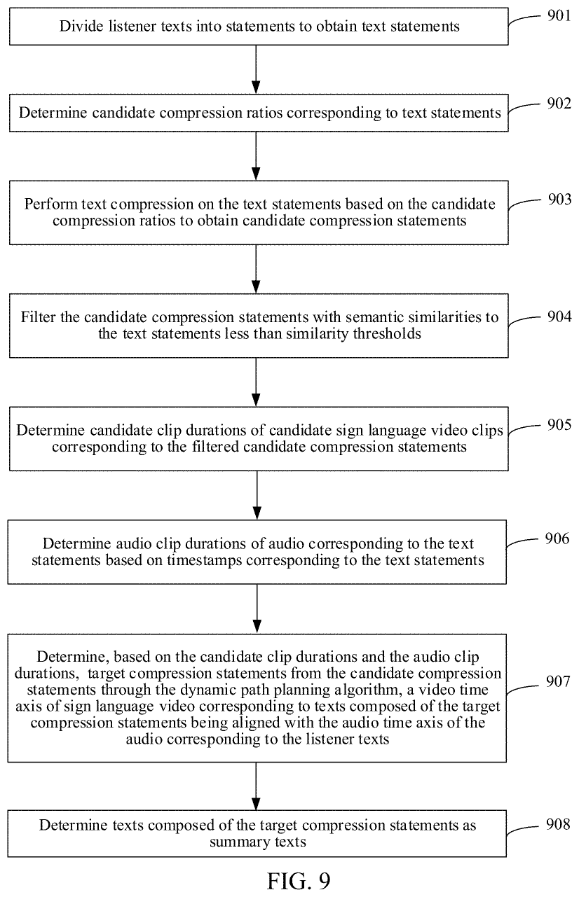

The summary text obtained by the computer device using the method of extracting key statements by semantic analysis on the listener text has been described above, and the summary text obtained by the computer device using the method of text compression on the listener text are described below. Referring to FIG. 9, a flowchart of a method for generating summary text provided by another exemplary embodiment of this application is illustrated. The method includes the following steps:

Step 901: Divide the listener text into statements to obtain text statements.

Since, in the embodiments of this application, the listener text are offline texts, the computer device can obtain all the contents of the listener text. In one possible implementation, the computer device divides the listener text based on punctuation symbols, resulting in text statements. The punctuation symbols may be a punctuation symbol indicating the end of a sentence, such as a period, an exclamation mark, and a question mark.

Illustratively, the listener text is “Winter Olympics Games” is located is the key statement, that is, “The 2022 Winter Olympic Games will be held at XX; the mascot of this Winter Olympic Games is XXX; and the slogan of this Winter Olympic Games is ‘XXXXX’. I look forward to the coming of the Olympic Winter Games”. The computer device divides the above listener text, and obtains three text statements, and the first text statement S1 is “The 2022 winter Olympic Games will be held at XX”. The second text statement S2 is “The mascot of this Winter Olympic Games is XXX”. The third text statement S3 is “The slogan of this Winter Olympic Games is ‘XXXXX’ ”. The fourth text statement S4 is “I look forward to the coming of the Olympic Winter Games”.

Step 902: Determine candidate compression ratios corresponding to the text statements.

In one possible implementation, a plurality of candidate compression ratios are preset in the computer device, and the computer device can select a candidate compression ratio for each text statement from the preset candidate compression ratios.

In some embodiments, the candidate compression ratios for each text statement may be the same or different, which are not limited by the embodiments of this application.

In some embodiments, one text statement corresponds to a plurality of candidate compression ratios.

Illustratively, as shown in Table 6, the computer device determines three candidate compression ratios for each of the foregoing four text statements.

TABLE 6

| | Candidate | Candidate | Candidate |
|---|---|---|---|
| Text | compression | compression | compression |
| statement | ratio 1 | ratio 2 | ratio 3 |
| S1 | Y11 | Y12 | Y13 |
| S2 | Y21 | Y22 | Y23 |
| S3 | Y31 | Y32 | Y33 |
| S4 | Y41 | Y42 | Y43 |

Ymn is used for the candidate compression ratio n corresponding to an m^{th} text statement, for example, Y11 is used for characterizing the candidate compression ratio 1 corresponding to the first text statement S1. In addition, in order to reduce the calculation amount of the computer device, each text statement selects the same candidate compression ratio, for example, the computer device performs text compression on the text statements S1, S2, S3, and S4 using the candidate compression ratio 1. The computer device may also perform text compression on the text statements S1, S2, S3, and S4 using different candidate compression ratios, which is not limited in the embodiments of this application.

Step 903: Perform text compression on the text statements based on the candidate compression ratio to obtain candidate compression statements.

Illustratively, the computer device performs text compression on the text statements S1, S1, S2, S3, and S4 based on the candidate compression ratio 1, the candidate compression ratio 2, and the candidate compression ratio 3 determined in Table 6 to obtain candidate compression statements corresponding to each text statement, as shown in Table 7.

TABLE 7

| Text statement | Candidate compression statement | | |
|---|---|---|---|
| S1 | C11 | C12 | C13 |
| S2 | C21 | C22 | C23 |
| S3 | C31 | C32 | C33 |
| S4 | C41 | C42 | C43 |

Cmn is used for characterizing candidate compression statements obtained by performing text compression on the m^{th} text statement via a candidate compression ratio n, for example, C11 is used for characterizing a candidate compression statement obtained by performing text compression on the first text statement S1 via a candidate compression ratio 1.

Step 904: Filter the candidate compression statements with semantic similarities to the text statements less than similarity thresholds.

In the embodiments of this application, in order to ensure the consistency between the content of the finally generated sign language video and the content of the original listener text, and avoid interfering with the understanding of the hearing-impaired person, in the embodiments of this application, the computer device needs to perform semantic analysis on the candidate compression ratio, compare same with the semantics of the corresponding text statement, determine the semantic similarity between the candidate compression statement and the corresponding text statement, and filter the candidate compression ratio which does not match the semantics of the text statement.

In one possible implementation, when the semantic similarity is greater than or equal to the similarity threshold, indicating a high probability that the candidate compression statement is similar to the corresponding text statement, the computer device retains the candidate compression statements.

In another possible embodiment, the computer device filters the candidate compression statement when the semantic similarity is less than the similarity threshold, indicating to the corresponding text compression statement with a high probability, the computer device filters the candidate compression statements.

In some embodiments, the similarity threshold is 90%, 95%, 98%, and the like, which is not limited in the embodiments of this application.

Illustratively, the computer device filters the candidate compression statements in Table 6 based on the similarity threshold to obtain filtered candidate compression statements, as shown in Table 8.

TABLE 8

| Text statement | Filtered candidate compression statement | | |
|---|---|---|---|
| S1 | | C12 | C13 |
| S2 | C21 | | C23 |
| S3 | C31 | | |
| S4 | C41 | C42 | C43 |

The deleted candidate compression statement represents candidate compression statements filtered by the computer device.

Step 905: Determine candidate clip durations of candidate sign language video clips corresponding to the filtered candidate compression statements.

To ensure that the time axis of the last generated sign language video is aligned with the audio time axis of the audio corresponding to the listener text, the computer device first determines the duration of the candidate sign language video clip corresponding to the filtered compression statement.

Illustratively, as shown in Table 9, the computer device determines the candidate clip durations of candidate sign language video clips corresponding to the filtered candidate compression statements.

TABLE 9

| | Audio clip | | Candidate | | Candidate | | Candidate |
|---|---|---|---|---|---|---|---|
| | durations | Filtered | sign | Filtered | sign | Filtered | sign |
| | corresponding | candidate | language | candidate | language | candidate | language |
| Text | to text | compression | clip | compression | clip | compression | clip |
| statement | statements | statement | durations | statement | durations | statement | durations |
| S1 | T1 | | | C12 | T12 | C13 | T13 |
| S2 | T2 | C21 | T21 | | | C23 | T23 |
| S3 | T3 | C31 | T31 | | | | |
| S4 | T4 | C41 | T41 | C42 | T42 | C43 | T43 |

Tmn is used for representing a candidate sign language clip duration corresponding to the filtered candidate compression statement Cmn, and T1, T2, T3, and T4 respectively represent the audio clip duration of audio corresponding to the text statements S1, S2, S3, and S4.

Step 906: Determine audio clip durations of audio corresponding to the text statements based on timestamps corresponding to the text statements.

In the embodiments of this application, the listener text contain timestamps. In one possible implementation, the computer device obtains a timestamp corresponding to the listener text while obtaining the listener text for subsequent synchronized alignment of the sign language video with the corresponding audio based on the timestamp. The timestamps are used for indicating a time interval of audio corresponding to the listener text on an audio time axis.

Illustratively, the content of the listener text is “hello, spring”, the content of the audio time axis corresponding to the audio is “hello” for 00:00:00-00:00:70, and “spring” for 00:00:70-00:01:35. “00:00:00-00:00:70” and “00:00:70-00:01:35” are the timestamps corresponding to the listener text.

In the embodiments of this application, since the computer device acquires the listener text in different ways, the computer device acquires the timestamp in different ways.

Illustratively, when a computer device directly obtains listener text, the listener text need to be converted to corresponding audio to obtain its corresponding timestamp. Illustratively, the computer device may also extract the timestamp corresponding to the listener text directly from the subtitle file. Illustratively, when a computer device obtains a timestamp from an audio file, the audio file needs to be first performed with speech recognition, and the timestamp is obtained based on the result of the speech recognition and the audio time axis. Illustratively, when a computer device obtains a timestamp from a video file, it is necessary to first perform character recognition on the video file and obtain the timestamp based on the character recognition result and the video time axis.

Therefore, it can be seen therefrom that in the embodiments of this application, a computer device can obtain an audio clip of audio corresponding to each text statement based on a timestamp of listener text.

Illustratively, as shown in Table 9, text statement S1 corresponds to audio having an audio clip duration of T1, text statement S2 corresponds to audio having an audio clip duration of T2, text statement S3 corresponds to audio having an audio clip duration of T3, and text statement S4 corresponds to audio having an audio clip duration of T4.

Step 907: Determine, based on the candidate clip durations and the audio clip durations, the target compression statements from the candidate compression statements through the dynamic path planning algorithm, a video time axis of sign language video corresponding to texts composed of the target compression statements being aligned with the audio time axis of the audio corresponding to the listener text.

In one possible implementation, the computer device determines the target compression statements from candidate compression statements corresponding to each text statement based on the dynamic path planning algorithm. The path nodes in the dynamic path planning algorithm are candidate compression statements.

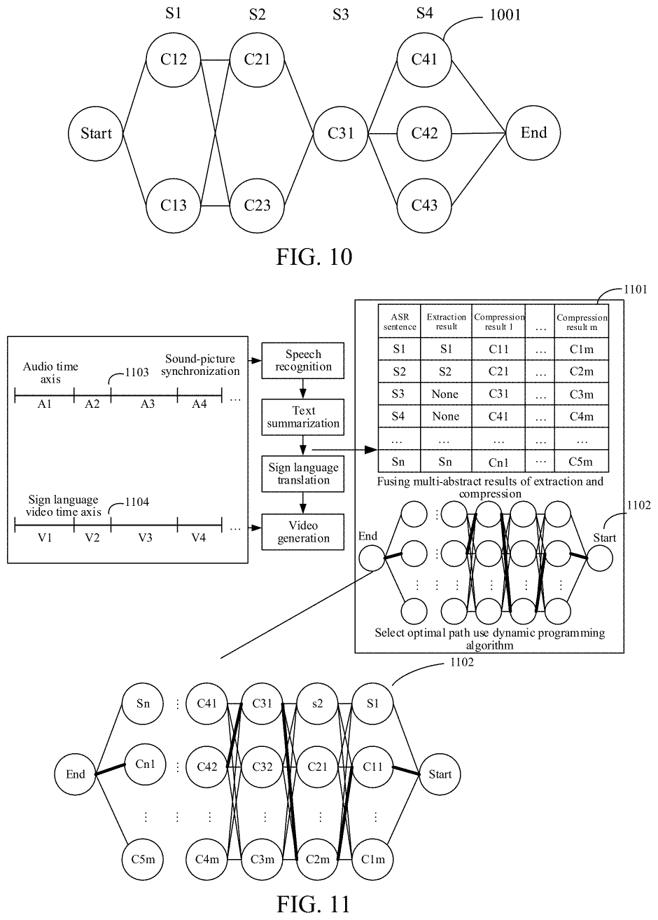

Illustratively, the process of the dynamic path planning algorithm is described in conjunction with Table 8 and FIG. 10. Each column of path nodes 1001 in the dynamic path planning algorithm represents a different candidate compression statement of text statements. For example, the first column of path nodes 1001 is used for representing different candidate compression statements of the text statement S1. As shown in Table 10, the computer device combines the candidate texts obtained by different candidate compression statements obtained by the dynamic path planning algorithm and the video duration of the corresponding sign language video; the video duration of the sign language video corresponding to the candidate texts are obtained by the candidate sign language video clip duration corresponding to each candidate compression statement.

TABLE 10

| | Duration of sign language video |
|---|---|
| Candidate text | corresponding to the candidate text |
| C12 + C21 + C31 + C41 | T12 + T21 + T31 + T41 |
| C12 + C21 + C31 + C42 | T12 + T21 + T31 + T42 |
| C12 + C21 + C31 + C43 | T12 + T21 + T31 + T43 |
| C12 + C23 + C31 + C41 | T12 + T23 + T31 + T41 |
| C12 + C23 + C31 + C42 | T12 + T23 + T31 + T42 |
| C12 + C23 + C31 + C43 | T12 + T23 + T31 + T43 |
| C13 + C21 + C31 + C41 | T13 + T21 + T31 + T41 |
| C13 + C21 + C31 + C42 | T13 + T21 + T31 + T42 |
| C13 + C23 + C31 + C43 | T13 + T23 + T31 + T43 |
| C13 + C23 + C31 + C41 | T13 + T23 + T31 + T41 |
| C13 + C23 + C31 + C42 | T13 + T23 + T31 + T42 |
| C13 + C23 + C31 + C43 | T13 + T23 + T31 + T43 |

Further, the computer device obtains a time axis of the sign language video corresponding to the candidate text based on the duration of the sign language video corresponding to the candidate text, matches the audio time axis of the audio corresponding to the combination of the listener text, namely, the text statements S1, S2, S3, and S4, and determines a target candidate text if the two are aligned, determines target compression statements based on the target candidate text, and then the computer device determines the target compression statements based on the dynamic path planning algorithm. In FIG. 10, the computer device determines target compression statements based on the dynamic path planning algorithm as C12, C23, C31, and C41.

Step 908: Determine texts composed of the target compression statements as the summary text.

Illustratively, the computer device determines as summary text the text formed by the target compression statement, that is, C12+C23+C31+C41.

In the embodiments of this application, a computer device determines target compression statements from candidate compression statements based on a similarity threshold value and a dynamic path planning algorithm, and then obtains a summary text, so that the text length of listener text are shortened, and the problem that the finally generated sign language video and the corresponding audio are not synchronized can be avoided, and the synchronization between the sign language video and the audio is improved.

In addition, in one possible embodiment, when the listener text are offline texts, the computer device may combine the method of performing statement analysis on the listener text to extract key statements and the method of performing text compression on the listener text according to the compression ratio to obtain the summary text. Illustratively, as shown in FIG. 11, first, the computer device obtains the listener text of a video file and a corresponding timestamp based on a speech recognition method. Second, the computer device performs text summarization processing on the listener text. The computer device performs semantic analysis on the listener text, and extracts a key statement from the listener text based on the result of the semantic analysis to obtain the extraction result in Table 1101, the key statement being a text statement S1 to S2 and a text statement S5 to Sn. At the same time, the computer device performs statement processing on the listener text to obtain text statements S1 to Sn. Further, the computer device performs text compression on the text statements based on the candidate compression ratios to obtain the candidate compression statement to obtain the compression type result 1 to the compression type result m in Table 1101. Cnm is used for representing the candidate compression statements.

Furthermore, the computer device determines target compression statements Cn1, . . . , C42, C31, C2m, and C11 from Table 1101 based on the dynamic path planning algorithm 1102; the video time axis of the sign language video corresponding to the text composed of the target compression statements are aligned with the audio time axis of the audio corresponding to the listener text. The summary text are generated based on the target compression statement. Furthermore, the summary text are the sign language translated to obtain sign language text, and sign language video is generated based on the sign language text. The time axis 1104 of the resulting sign language video is aligned with the audio time axis 1103 of the corresponding audio of the video due to text summarization of the listener files.

In the above embodiments, on the one hand, the semantic accuracy of the summary text are improved by filtering candidate compression statements whose semantic similarity with the text statement is less than the similarity threshold value, so that the sign language video can be expressed more accurately in semantic terms; on the other hand, by determining the candidate clip duration and the audio clip duration, the target compression statements are determined from the candidate compression statements by the dynamic path planning algorithm, so that the time axis of the sign language video can be aligned with the audio time axis, and the accuracy of the sign language video can be further improved.

In the embodiments of this application, when the listener text are real-time texts, the computer device obtains the listener text statement by statement, but cannot obtain all the content of the listener text, and therefore the summary text cannot be obtained by extracting the key statement through semantic analysis on the listener text. In order to reduce the time delay, the computer device performs text compression on the listener text according to the fixed compression ratio, and then obtains the summary text. The method is described below:

1. Based on the application scenario corresponding to the listener text, the target compression ratio is determined.

The target compression ratio is related to an application scenario corresponding to the listener text, and the target compression ratio determined by different application scenarios is different.

Illustratively, when the application scenario corresponding to the listener text are interview scenario, the target compression ratio is determined to be a high compression ratio, for example, 0.8, because in the interview scenario, the terms of the listener text are more spoken and less effective.

Illustratively, when the application scenario corresponding to the listener text are news simulcast scenario or a news conference scenario, the expression of the listener text is more concise and has more effective information, and therefore the target compression ratio is determined to be a low compression ratio, for example, 0.4.

2. Based on the target compression ratio, the listener text are compressed to obtain the summary text.

The computer device performs statement-by-statement compression on the listener text according to the determined target compression ratio, and then obtains the summary text.

In the embodiments of this application, when the listener text are real-time texts, the computer device performs text compression on the listener text based on the target compression ratio, shortens the text length of the listener text, improves the synchronization of the finally generated sign language video and the corresponding audio thereof, and in addition, different application scenarios determine different target compression ratios, to improve the accuracy of the finally generated sign language video.

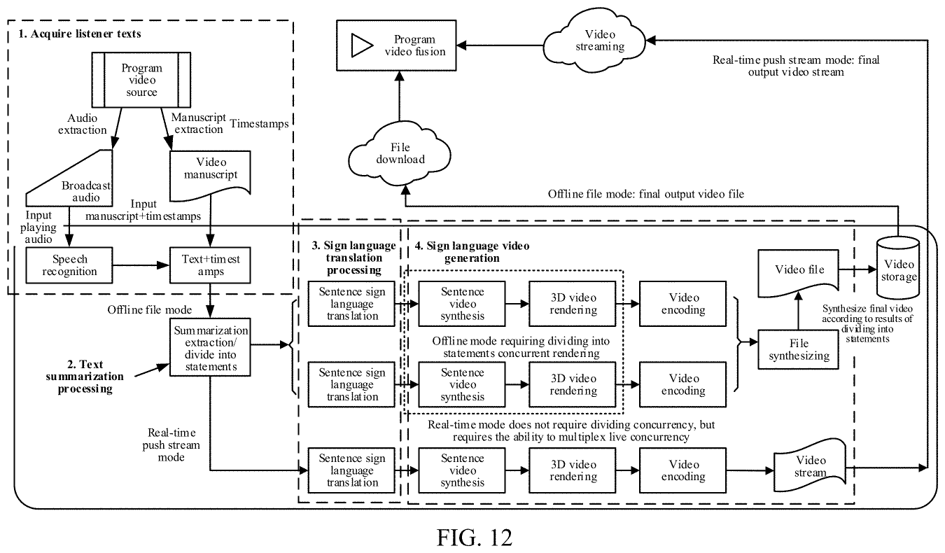

Referring to FIG. 12, it illustrates a flowchart of a method for generating sign language video provided by one exemplary embodiment of this application. In the embodiments of this application, the method for generating sign language video includes acquiring listener text, text summarization processing, sign language translation processing, and sign language video generation.

First, listener text are acquired. The program video source includes an audio file, a video file, a ready listener text and a subtitle file, and the like. Taking an audio file and a video file as an example, for the audio file, a computer device performs audio extraction to obtain broadcast audio, and further, the computer device processes the broadcast audio via a speech recognition technology to obtain listener text and corresponding timestamps. For a video file, the computer device extracts the corresponding listener text and the corresponding timestamp of the video based on OCR technology.

Second, text summarization processing is performed. The computer device performs text summarization processing on the listener text to obtain summary text. The processing method includes extracting key statements based on semantic analysis of the listener text and performing text compression after statement segmentation on the listener text. In addition, the types of the listener text are different, and the method for the computer device to process the text abstract of the listener text are different. When the type of the listener text are offline texts, the computer device may perform text summarization processing on the listener text using a method for extracting key statements based on semantic analysis on the listener text, or perform text summarization processing on the listener text using a method for performing text compression after statement segmentation on the listener text, or a combination of the foregoing two methods. However, when the type of the listener text are real-time texts, the computer device can only perform text summarization processing on the listener text by performing text compression after statement segmentation on the listener text.

Third, sign language translation processing is performed. The computer device performs sign language translation on the summary text generated based on the text summarization processing to generate sign language text.

Fourth, sign language video is generated. In different modes, sign language video is generated in different ways. In an offline mode, a computer device needs to divide sign language text and compose a sentence video by taking a text statement as a unit; Further, 3D rendering is performed on the sentence video. Further, video encoding is performed. Finally, the video encoding files of all sentences are synthesized to generate the final sign language video. Further, the computer device stores the sign language video into the cloud server, and can download the sign language video from the computer device when the user needs to watch the sign language video.

However, in real-time mode, the computer device does not divide the listener text statements, but needs multi-path live broadcast and concurrency to reduce the delay. The computer device synthesizes sentence video based on sign language text. Further, 3D rendering is performed on the sentence video. Further, video encoding is performed to generate a video stream. The computer device pushes the video stream to generate sign language video.

It is to be understood that, although the steps are displayed sequentially according to the instructions of the arrows in the flowcharts of the embodiments, these steps are not necessarily performed sequentially according to the sequence instructed by the arrows. Unless explicitly stated herein, there are no strict order restrictions on performing these steps, and these steps may be performed in other orders. Moreover, at least some of the steps in each embodiment may include a plurality of sub-steps or a plurality of stages. The sub-steps or stages are not necessarily performed at the same moment but may be performed at different moments. Execution of the sub-steps or stages is not necessarily sequentially performed, but may be performed alternately with other steps or at least some of sub-steps or stages of other steps.

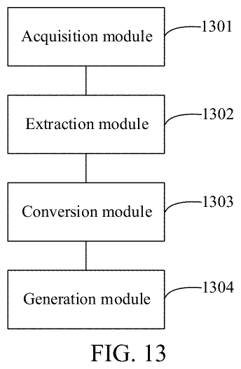

Referring to FIG. 13, it illustrates a structural block diagram of an apparatus for generating sign language video provided by an exemplary embodiment of this application. The apparatus may include:
an acquisition module 1301, configured to acquire listener text, the listener text being texts conforming to grammatical structures of a hearing-friendly person;
an extraction module 1302, configured to perform summarization extraction on the listener text to obtain summary text, a text length of the summary text being shorter than a text length of the listener text;
a conversion module 1303, configured to convert the summary text into sign language text, the sign language text being texts conforming to grammatical structures of a hearing-impaired person; and
a generation module 1304, configured to generate the sign language video based on the sign language text.

In some embodiments, the extraction module 1302 is configured to perform semantic analysis on the listener text; extract key statements from the listener text based on semantic analysis results, the key statements being statements for expressing full-text semantics in the listener text; and determine the key statements as summary text.

In some embodiments, the extraction module 1302 is configured to perform semantic analysis on the listener text when the listener text are offline texts.

In some embodiments, the extraction module 1302 is configured to perform text compression on the listener text and determine the compressed listener text as the summary text.

In some embodiments, the extraction module 1302 is configured to perform text compression on the listener text when the listener text are offline texts.

In some embodiments, the extraction module 1302 is configured to perform text compression on the listener text when the listener text are real-time texts.

In some embodiments, the extraction module 1302 is configured to divide, when the listener text are the offline texts, the listener text into statements to obtain text statements; determine candidate compression ratios corresponding to the text statements; and perform text compression on the text statements based on the candidate compression ratios to obtain candidate compression statements. The extraction module 1302 is configured to determine target compression statements from the candidate compression statements based on a dynamic path planning algorithm, path nodes in the dynamic path planning algorithm being the candidate compression statements; and determine texts composed of the target compression statements as the summary text.

In some embodiments, the listener text contain corresponding timestamps, and the timestamps are used for indicating a time interval of audio corresponding to the listener text on an audio time axis. The extraction module 1302 is configured to determine candidate clip durations of candidate sign language video clips corresponding to the candidate compression statements; determine audio clip durations of audio corresponding to the text statements based on timestamps corresponding to the text statements; and determine, based on the candidate clip durations and the audio clip durations, the target compression statements from the candidate compression statements through the dynamic path planning algorithm, a video time axis of sign language video corresponding to texts composed of the target compression statements being aligned with the audio time axis of the audio corresponding to the listener text.

In some embodiments, the apparatus further includes: a filtering module, configured to filter the candidate compression statements with semantic similarities to the text statements less than similarity thresholds; and the extraction module 1302, configured to determine candidate clip durations of candidate sign language video clips corresponding to the filtered candidate compression statements.

In some embodiments, the extraction module 1302 is configured to perform, when the listener text are the real-time texts, text compression on the listener text based on a target compression ratio.

In some embodiments, the apparatus further includes: a determination module, configured to determine the target compression ratio based on application scenarios corresponding to the listener text, different application scenarios corresponding to different compression ratios.

In some embodiments, the conversion module 1303 is configured to input the summary text into a translation model to obtain the sign language text output by the translation model, the translation model being obtained by training based on sample text pairs composed of sample sign language text and sample listener text.

In some embodiments, the generation module 1304 is configured to acquire sign language gesture information corresponding to sign language words in the sign language text; control the virtual object to perform sign language gestures in sequence based on the sign language gesture information; and generate the sign language video based on a picture of the virtual object in performing the sign language gestures.

In some embodiments, the acquisition module 1301 is configured to: acquire the input listener text; acquire a subtitle file, and extract the listener text from the subtitle file; acquire an audio file, perform speech recognition on the audio file to obtain a speech recognition result, and generate the listener text based on the speech recognition result; and acquire a video file, perform character recognition on video frames of the video file to obtain a character recognition result, and generate the listener text based on the character recognition result.

In summary, in the embodiments of this application, the summary text are obtained by performing text summarization extraction on the listener text, and then the text length of the listener text are shortened, so that the finally generated sign language video can keep synchronization with the audio corresponding to the listener text. Since the sign language video is generated based on the sign language text after the summary text are converted into the sign language text conforming to the grammatical structures of a hearing-impaired person, the sign language video can better express the content to a hearing-impaired person, improving the accuracy of the sign language video.

It should be noted that the wireless network access apparatus provided in the foregoing embodiments is illustrated with an example of division of the foregoing function modules. In practical application, the foregoing functions may be allocated to and completed by different function modules according to requirements, that is, the internal structure of the apparatus is divided into different function modules, to complete all or part of the functions described above. In addition, the apparatus provided in the foregoing embodiments and the method embodiments fall within a same conception. For details of a specific implementation process, refer to the method embodiments. In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Details are not described herein again.

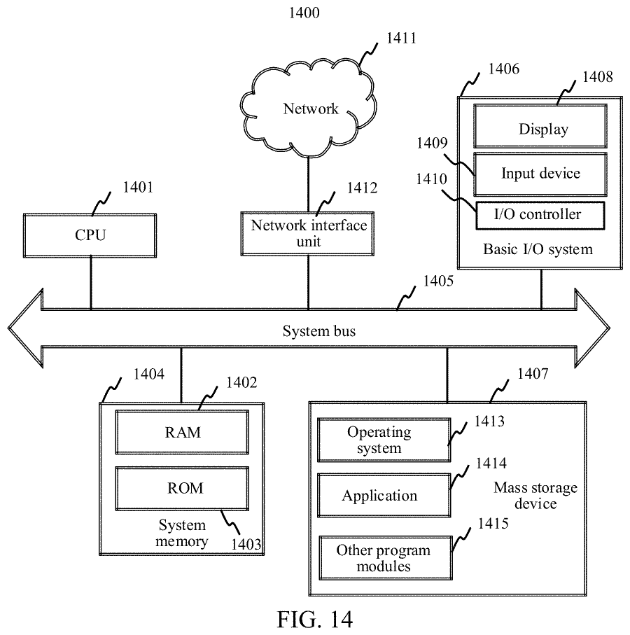

FIG. 14 is a structural diagram of a computer device according to an exemplary embodiment. Computer device 1400 includes a central processing unit (CPU) 1401, a system memory 1404 including a random-access memory (RAM) 1402 and a read-only memory (ROM) 1403, and a system bus 1405 coupling the system memory 1404 and the CPU 1401. Computer device 1400 also includes a basic input/output (I/O) system 1406 that facilitates transfer of information between elements within the computer device, and a mass storage device 1407 that stores an operating system 1413, applications 1414, and other program modules 1415.

The basic I/O system 1406 includes a display 1408 for displaying information and an input device 1409 such as a mouse and a keyboard for inputting information by a user. The display 1408 and the input device 1409 are connected to the CPU 1401 through an I/O controller 1410 which is connected to the system bus 1405. The basic I/O system 1406 may also include an I/O controller 1410 for receiving and processing input from a couple of other devices, such as a keyboard, mouse, or electronic stylus. Similarly, the I/O controller 1410 also provides output to a display screen, printer, or other type of output device.

The mass storage device 1407 is connected to the CPU 1401 through a mass storage controller (not shown) that is connected to the system bus 1405. The mass storage device 1407 and its associated computer device-readable media provide non-volatile storage for the computer device 1400. That is, the mass storage device 1407 may include a computer device-readable medium (not shown) such as a hard disk or a compact disc read-only memory (CD-ROM) drive.

Without loss of generality, computer device-readable media can include computer device storage media and communication media. Computer device storage media includes volatile and nonvolatile, and removable and non-removable media implemented in any method or technology for storage of information such as computer device readable instructions, data structures, program modules or other data. Computer device storage media include RAM, ROM, erasable programmable read only memory (EPROM), electrically erasable programmable read-only memory (EEPROM), CD-ROM, digital video disc (DVD) or other optical storage, magnetic cassettes, magnetic tape, magnetic disk storage or other magnetic storage devices. Of course, those skilled in the art will recognize that computer device storage media are not limited to the above. The system memory 1404 and mass storage device 1407 described above may be collectively referred to as the memory.

According to various embodiments of the present disclosure, the computer device 1400 may also operate as a remote computer device connected to a network via a network such as the Internet. That is, the computer device 1400 may be connected to the network 1411 through a network interface unit 1412 coupled to the system bus 1405, or the network interface unit 1415 may be used to connect to other types of networks or remote computer device systems (not shown).

The memory also includes one or more computer-readable instructions, one or more computer-readable instructions being stored in the memory, and the central processor 1401 implements all or part of the steps of the above method for generating sign language video by executing the one or more programs.

In one embodiment, there is provided a computer device including a memory and a processor, the memory storing computer programs, and the computer programs, when executed by the processor, implementing steps of the method for generating sign language video.

In one embodiment, there is provided a computer-readable storage medium storing thereon computer programs, the computer programs, when executed by the processor, implementing steps of the method for generating sign language video.

In one embodiment, there is provided a computer program product including computer programs, the computer programs, when executed by the processor, implementing steps of the method for generating sign language video.

It should be noted that the user information (including but not limited to user equipment information, user personal information, and the like) and data (including but not limited to data used for analysis, stored data, displayed data, and the like) involved in this application are information and data authorized by the user or fully authorized by all parties. The collection, use, and processing of relevant data shall comply with relevant laws and regulations and standards of relevant countries and regions.

Each technical feature of the above embodiments may be arbitrarily combined. In order to make the description concise, not all the possible combinations of each technical feature in the above embodiments are described. However, unless there is no contradiction between the combinations of these technical features, they are to be considered as the scope of the specification.

The above embodiments only describe several implementations of this application specifically and in detail, but cannot be construed as a limitation to the patent scope of this application. The ordinarily skilled in the art would have been able to make several variations and modifications without departing from the concept of this application, which fall within the scope of this application. Therefore, the protection scope of the patent of this application shall be subject to the appended claims.

What is claimed is:

1. A method for generating a sign language video performed by a computer device, the method comprising:
acquiring listener text, the listener text conforming to grammatical structures of a hearing-friendly person;
performing summarization extraction on the listener text to obtain summary text, a text length of the summary text being shorter than a text length of the listener text;
converting the summary text into sign language text, the sign language text conforming to grammatical structures of a hearing-impaired person; and
generating the sign language video based on the sign language text.

2. The method according to claim 1, wherein the performing summarization extraction on the listener text to obtain summary text comprises:
performing semantic analysis on the listener text;
extracting key statements from the listener text based on semantic analysis results, the key statements being statements for expressing full-text semantics in the listener text; and
determining the key statements as the summary text.

3. The method according to claim 1, wherein the performing summarization extraction on the listener text to obtain summary text comprises:
performing text compression on the listener text; and
determining the compressed listener text as the summary text.

4. The method according to claim 3, wherein the performing text compression on the listener texts comprises:
performing text compression on the listener texts in a case that the listener texts are real-time texts.

5. The method according to claim 1, wherein the converting the summary text into sign language text comprises:
inputting the summary text into a translation model to obtain the sign language text output by the translation model, the translation model being obtained by training based on sample text pairs composed of sample sign language text and sample listener text.

6. The method according to claim 1, wherein the generating the sign language video based on the sign language text comprises:
acquiring sign language gesture information corresponding to sign language words in the sign language text;
controlling a virtual object to perform sign language gestures in sequence based on the sign language gesture information; and
generating the sign language video based on a picture of the virtual object in performing the sign language gestures.

7. The method according to claim 1, wherein the acquiring listener text comprises at least one of the following manners:
acquiring the input listener text;
acquiring a subtitle file, and extracting the listener text from the subtitle file;
acquiring an audio file, performing speech recognition on the audio file to obtain a speech recognition result, and generating the listener text based on the speech recognition result; and
acquiring a video file, performing character recognition on video frames of the video file to obtain a character recognition result, and generating the listener text based on the character recognition result.

8. A computer device comprising a memory and a processor, the memory storing computer-readable instructions, and the computer-readable instructions, when executed by the processor, causing the computer device to perform a method for generating a sign language video including:
acquiring listener text, the listener text conforming to grammatical structures of a hearing-friendly person;
performing summarization extraction on the listener text to obtain summary text, a text length of the summary text being shorter than a text length of the listener text;
converting the summary text into sign language text, the sign language text conforming to grammatical structures of a hearing-impaired person; and
generating the sign language video based on the sign language text.

9. The computer device according to claim 8, wherein the performing summarization extraction on the listener text to obtain summary text comprises:
performing semantic analysis on the listener text;
extracting key statements from the listener text based on semantic analysis results, the key statements being statements for expressing full-text semantics in the listener text; and
determining the key statements as the summary text.

10. The computer device according to claim 8, wherein the performing summarization extraction on the listener text to obtain summary text comprises:
performing text compression on the listener text; and
determining the compressed listener text as the summary text.

11. The computer device according to claim 10, wherein the performing text compression on the listener texts comprises:
performing text compression on the listener texts in a case that the listener texts are real-time texts.

12. The computer device according to claim 8, wherein the converting the summary text into sign language text comprises:
inputting the summary text into a translation model to obtain the sign language text output by the translation model, the translation model being obtained by training based on sample text pairs composed of sample sign language text and sample listener text.

13. The computer device according to claim 8, wherein the generating the sign language video based on the sign language text comprises:
acquiring sign language gesture information corresponding to sign language words in the sign language text;
controlling a virtual object to perform sign language gestures in sequence based on the sign language gesture information; and
generating the sign language video based on a picture of the virtual object in performing the sign language gestures.

14. The computer device according to claim 8, wherein the acquiring listener text comprises at least one of the following manners:
acquiring the input listener text;
acquiring a subtitle file, and extracting the listener text from the subtitle file;
acquiring an audio file, performing speech recognition on the audio file to obtain a speech recognition result, and generating the listener text based on the speech recognition result; and
acquiring a video file, performing character recognition on video frames of the video file to obtain a character recognition result, and generating the listener text based on the character recognition result.

15. A non-transitory computer-readable storage medium storing thereon computer-readable instructions, the computer-readable instructions, when executed by a processor of a computer device, causing the computer device to perform a method for generating a sign language video including:
acquiring listener text, the listener text conforming to grammatical structures of a hearing-friendly person;
performing summarization extraction on the listener text to obtain summary text, a text length of the summary text being shorter than a text length of the listener text;
converting the summary text into sign language text, the sign language text conforming to grammatical structures of a hearing-impaired person; and
generating the sign language video based on the sign language text.

16. The non-transitory computer-readable storage medium according to claim 15, wherein the performing summarization extraction on the listener text to obtain summary text comprises:
performing semantic analysis on the listener text;
extracting key statements from the listener text based on semantic analysis results, the key statements being statements for expressing full-text semantics in the listener text; and
determining the key statements as the summary text.

17. The non-transitory computer-readable storage medium according to claim 15, wherein the performing summarization extraction on the listener text to obtain summary text comprises:
performing text compression on the listener text; and
determining the compressed listener text as the summary text.

18. The non-transitory computer-readable storage medium according to claim 15, wherein the converting the summary text into sign language text comprises:
inputting the summary text into a translation model to obtain the sign language text output by the translation model, the translation model being obtained by training based on sample text pairs composed of sample sign language text and sample listener text.

19. The non-transitory computer-readable storage medium according to claim 15, wherein the generating the sign language video based on the sign language text comprises:
acquiring sign language gesture information corresponding to sign language words in the sign language text;
controlling a virtual object to perform sign language gestures in sequence based on the sign language gesture information; and
generating the sign language video based on a picture of the virtual object in performing the sign language gestures.

20. The non-transitory computer-readable storage medium according to claim 15, wherein the acquiring listener text comprises at least one of the following manners:
acquiring the input listener text;
acquiring a subtitle file, and extracting the listener text from the subtitle file;
acquiring an audio file, performing speech recognition on the audio file to obtain a speech recognition result, and generating the listener text based on the speech recognition result; and
acquiring a video file, performing character recognition on video frames of the video file to obtain a character recognition result, and generating the listener text based on the character recognition result.
